(19) United States
(12) Patent Application Publication
(10) Pub. No.: US 2026/0161520 A1
(43) Pub. Date: Jun. 11, 2026

(54) METHOD AND APPARATUS FOR COMMUNICATION BETWEEN FIRST DIE AND SECOND DIE

(71) Applicant: Electronics and Telecommunications Research Institute, Daejeon (KR)

(72) Inventors: Jae Woong CHOI, Daejeon (KR); Ju Yeob Kim, Daejeon (KR); Jin Ho Han, Daejeon (KR)

(73) Assignee: Electronics and Telecommunications Research Institute, Daejeon (KR)

(21) Appl. No.: 19/361,632

(22) Filed: Oct. 17, 2025

(30) Foreign Application Priority Data
Dec. 9, 2024 (KR) 10-2024-0181857
Mar. 13, 2025 (KR) 10-2025-0032647

(51) Int. Cl. G06F 11/263; G06F 11/14

(52) U.S. Cl. CPC G06F 11/263; G06F 11/1415

(57) ABSTRACT

A communication apparatus of an embodiment includes: a first interconnect block included in a first die and a second interconnect block included in a second die, each operating in a communication mode or a defect management mode that manages communication failures, and a connecting member that transfers data between the first interconnect block and the second interconnect block. The first interconnect block transmits a test pattern through the connecting member in the defect management mode, and the second interconnect block detects the communication failure by determining whether the test pattern received through the connecting member matches a predetermined test pattern.

### CROSS-REFERENCE TO RELATED APPLICATIONS

This application claims priority to Korean Patent Application Nos. 10-2024-0181857, filed on December 9, 2024 and 10-2025-0032647, filed on March 13, 2025, the entire contents of which are hereby incorporated by reference.

### BACKGROUND

The present disclosure generally relates to a method and apparatus for communication between a first die and a second die.

### DESCRIPTION OF THE RELATED ART

Recently, with the emergence of large-scale AI computational models such as generative AI (GPT, Copilot, Gemini), chiplet-based scalable AI computational devices have attracted attention. Consequently, lane recovery technology for data transmission between computational dies has become essential for ensuring data transmission stability. When some pads or bump connections in interfaces between computational dies fail, chip reliability cannot be guaranteed and chip cannot be normally operated.

To ensure data stability between die-to-die or die-to-memory communications, conventional designs include multi-die interconnect controllers such as IEEE 1500 controllers or UCIe controllers that support lane defect monitoring and lane recovery functions.

Conventional controllers used for chip testing and debugging perform connection state verification, independent testing at granular levels for memory channels or banks, defect analysis, and lane recovery by deactivating or bypassing paths where defects are detected. They also support multiple additional functions (Boundary Scan, MISR REGISTER).

Other conventional controllers perform high-speed, low-latency data transmission, compatibility with existing high-speed interfaces such as PCIe, CXL, HBM, power consumption control in multi-die connections, and lane recovery.

### SUMMARY

The conventional controllers described above provide many general-purpose functions performed between die-memory or die-to-die communications, such as connection state verification and fault repair for data transmission, low latency provision, bandwidth scalability, power consumption control, and protocol compatibility. This creates a difficulty in that data communication between NPUs provides unrequested functions, consuming larger area and power, making it resource inefficient.

One of the problems to be solved by the present disclosure is to address the difficulties of the conventional technology described above.

According to one aspect of the embodiments, a communication apparatus includes: a first interconnect block included in a first die and a second interconnect block included in a second die, each operating in a communication mode or a defect management mode that manages communication failures, and a connecting member that transfers data between the first interconnect block and the second interconnect block. The first interconnect block transmits a test pattern through the connecting member in the defect management mode, and the second interconnect block detects the communication failure by determining whether the test pattern received through the connecting member matches a predetermined test pattern.

According to one aspect of the embodiment, the first interconnect block includes a first control unit and a first lane recovery unit, the second interconnect block includes a second control unit and a second lane recovery unit, and the second control unit and the first control unit share data of the connecting member where the failure occurred and control the first lane recovery unit and the second lane recovery unit to bypass the connecting member where the failure occurred.

In this aspect, the connecting member includes a plurality of redundant connecting members, and in the communication mode, the first control unit and the second control unit control the first lane recovery unit and the second lane recovery unit to bypass the connecting member where the failure occurred and communicate through the redundant connecting member.

In this aspect, the first lane recovery unit includes a first TX lane recovery unit and a first RX lane recovery unit, the second lane recovery unit includes a second RX lane recovery unit and a second TX lane recovery unit, the first TX lane recovery unit is coupled with the second RX lane recovery unit, and the second TX lane recovery unit is coupled with the first RX lane recovery unit.

Also, in this aspect, in the defect management mode, the first RX lane recovery unit functions as a multiplexer, and the second RX lane recovery unit functions as a demultiplexer.

According to one aspect of the embodiment, the connecting member includes at least one of a bump and a pad.

According to one aspect of the embodiment, the first die includes a first NPU (Neural Processing Unit) connected to the first interconnect block, and the second die includes a second NPU connected to the second interconnect block.

According to one aspect of the embodiment, the communication apparatus is driven in the defect management mode during boot-up and periodically or intermittently during communication mode operation.

According to another embodiment, a method for driving a first interconnect block included in a first die and a second interconnect block included in a second die operating in communication mode and defect management mode includes: in the defect management mode: setting the first interconnect block included in the first die and the second interconnect block included in the second die to defect management mode respectively, transmitting a predetermined test pattern from the first interconnect block to the second interconnect block through a connecting member, and detecting a connecting member where failure occurred from the test pattern received by the second control unit. The communication mode includes: setting the first interconnect block and the second interconnect block to communication mode for mutual communication, and communicating while the first interconnect block and the second interconnect block bypass the detected failed connecting member.

According to one aspect of the embodiment, the first interconnect block includes a first control unit and a first lane recovery unit, the second interconnect block includes a second control unit and a second lane recovery unit, and in the defect management mode, the second control unit and the first control unit share data of the connecting member where the failure occurred.

In this aspect, in the communication mode, the first control unit and the second control unit control the first lane recovery unit and the second lane recovery unit to bypass the connecting member where the failure occurred and communicate through redundant connecting members.

In this aspect, the first lane recovery unit includes a first TX lane recovery unit and a first RX lane recovery unit, the second lane recovery unit includes a second RX lane recovery unit and a second TX lane recovery unit, the first TX lane recovery unit is coupled with the second RX lane recovery unit, and the second TX lane recovery unit is coupled with the first RX lane recovery unit.

Also, in this aspect, in the defect management mode, the first control unit controls the first TX lane recovery unit and first RX lane recovery unit to function as multiplexers, and the second control unit controls the second RX lane recovery unit and second TX lane recovery unit to function as demultiplexers.

According to one aspect of the embodiment, the connecting member includes at least one of a bump and a pad.

According to one aspect of the embodiment, the first die includes a first NPU (Neural Processing Unit) connected to the first interconnect block, and the second die includes a second NPU connected to the second interconnect block.

According to one aspect of the embodiment, the defect management mode is performed during boot-up of the first die and second die and periodically or intermittently while the first die and second die operate in the communication mode.

The present embodiment provides the advantage of being economical by reducing the die area required for formation and the power consumed during operation, in relation to detecting and recovering lane failures for data communication between two dies.

### BRIEF DESCRIPTION OF THE DRAWINGS

FIG. 1 is a block diagram illustrating an overview of the communication apparatus of the present embodiment.

FIG. 2 is a flowchart illustrating an overview of a method for driving a first interconnect block included in a first die and a second interconnect block included in a second die operating in communication mode and defect management mode of the present embodiment.

FIG. 3 is a diagram exemplarily showing when the communication apparatus of the present embodiment operates in defect management mode.

FIG. 4 is a diagram for schematically explaining the operation of the first TX lane recovery unit and first RX lane recovery unit and the second RX lane recovery unit and second TX lane recovery unit.

FIG. 5 is a schematic diagram for explaining when the communication apparatus operates in communication mode.

FIG. 6 is a diagram for schematically explaining the operation of the first TX lane recovery unit and first RX lane recovery unit and the second RX lane recovery unit and second TX lane recovery unit in communication mode.

### DETAILED DESCRIPTION OF THE EMBODIMENTS

The embodiments described herein are non-limiting example embodiments, and thus, the disclosure is not limited thereto and may be realized in various other forms.

As used herein, the term “and/or” includes any and all combinations of one or more of the associated listed items. For example, an expression, “a and/or b” should be understood as including only a, only b and both a and b. As used herein, an expression “at least one of” preceding a list of elements modifies the entire list of the elements and does not modify the individual elements of the list. For example, an expression, “at least one of a, b, and c” and “at least one of a, b, or c” should be understood as including only a, only b, only c, both a and b, both a and c, both b and c, or all of a, b, and c.

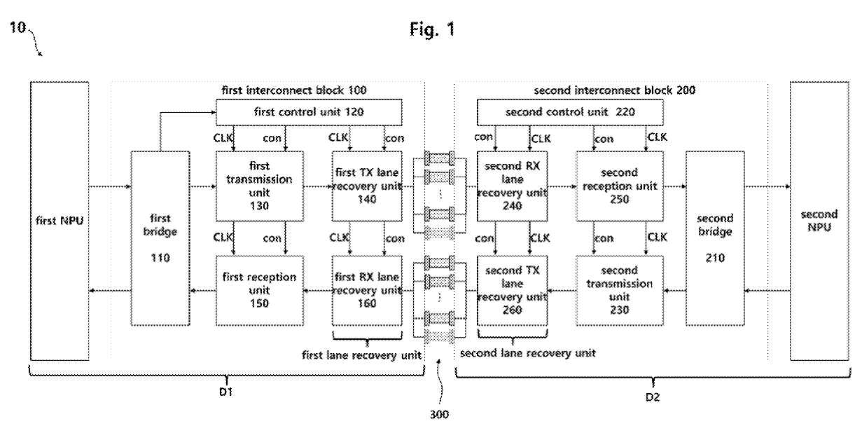

Hereinafter, the present embodiment will be described with reference to the accompanying drawings. FIG. 1 is a block diagram illustrating an overview of the communication apparatus 10 of the present embodiment. Referring to FIG. 1, the communication apparatus 10 of the present embodiment operates in a communication mode or a defect management mode that manages communication failures, and includes a first interconnect block 100 included in a first die D1, a second interconnect block 200 included in a second die D2, and a connecting member 300 that transfers data between the first interconnect block 100 and the second interconnect block 200. The first interconnect block 100 transmits a test pattern through the connecting member 300 in the defect management mode, and the second interconnect block 200 detects communication failure by determining whether the test pattern received through the connecting member 300 matches a predetermined test pattern. In one embodiment, the connection between the first NPU and first bridge and the connection between the second NPU and second bridge may be connected by AXI protocol bus.

Hererin, the first interconnect block 100 and the second interconnect block 200 may each be implemented by one or more integrated circuits, and the connecting member 300 may be implemented by one or more wires, one or more circuit boards, and/or one or more optical fibers, not being limited thereto, forming conductive media. The connecting member 300 may also include one or more serial or parallel databuses.

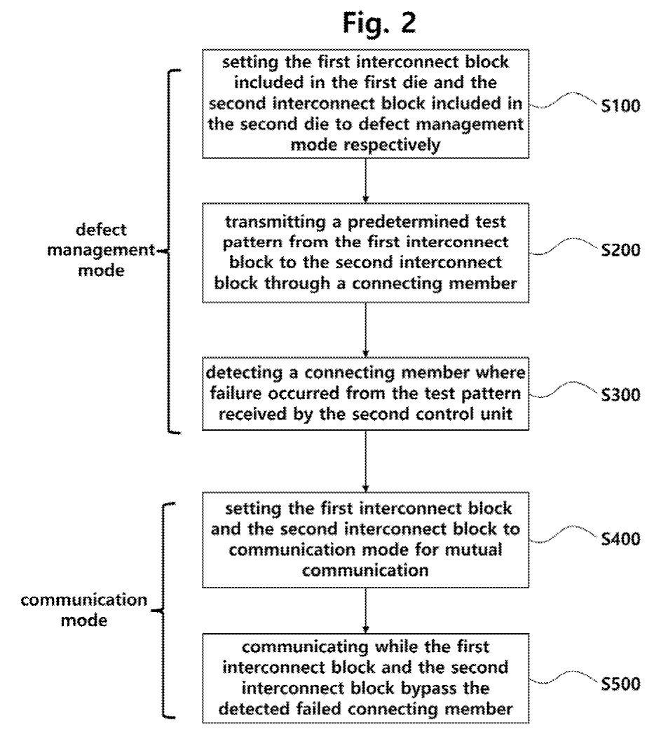

FIG. 2 is a flowchart illustrating an overview of a method for driving a first interconnect block included in a first die and a second interconnect block included in a second die operating in communication mode and defect management mode of the present embodiment. Referring to FIG. 2, the method includes: in the defect management mode: setting the first interconnect block included in the first die and the second interconnect block included in the second die to defect management mode respectively (S100), transmitting a predetermined test pattern from the first interconnect block to the second interconnect block through a connecting member (S200), and detecting a connecting member where failure occurred from the test pattern received by the second control unit (S300).

In the communication mode, the method includes setting the first interconnect block and the second interconnect block to communication mode for mutual communication (S400) and communicating while the first interconnect block and the second interconnect block bypass the detected failed connecting member (S500).

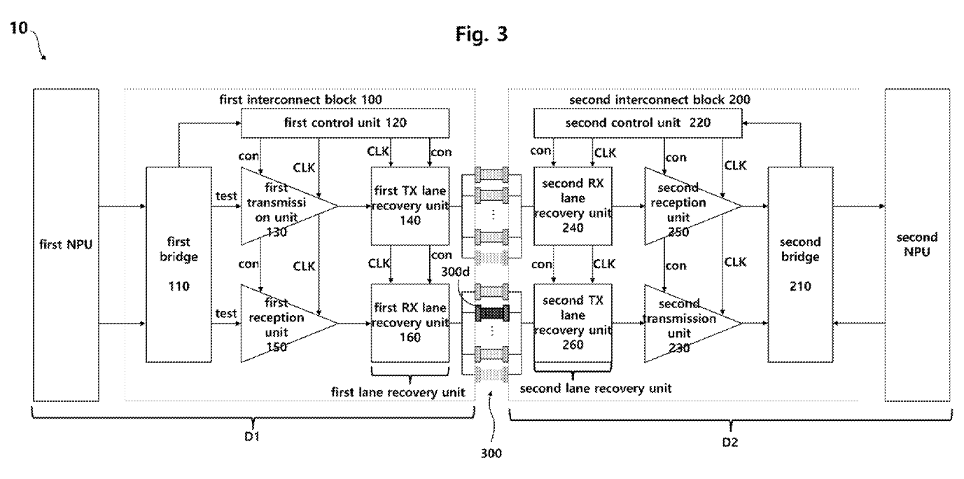

FIG. 3 is a diagram exemplarily showing when the communication apparatus 10 of the present embodiment operates in defect management mode, and the illustrated embodiment exemplifies that failure occurred in connecting member 300d. Referring to FIG. 3, when the communication apparatus 10 including the first interconnect block 100 and second interconnect block 200 boots up, it can operate in defect management mode.

In the defect management mode, a compiler can provide predetermined test patterns to the first die D1 and second die D2. The test patterns can be provided through the AXI protocol bus of each die and can be identical to each other.

In the defect management mode illustrated in FIG. 3, the first interconnect block 100 included in the first die D1 and the second interconnect block 200 included in the second die D2 are each set to defect management mode (S100). In the defect management mode, the first transmission unit 130 and first reception unit 150 of the first interconnect block 100 are controlled by the control signal con from the first control unit 120 to perform transmitter functions that transmit test patterns test to the second interconnect block 200. Also, the second transmission unit 230 and second reception unit 250 of the second interconnect block 200 are controlled by the control signal con from the second control unit 220 to perform receiver functions that receive the test pattern test provided by the first interconnect block 100.

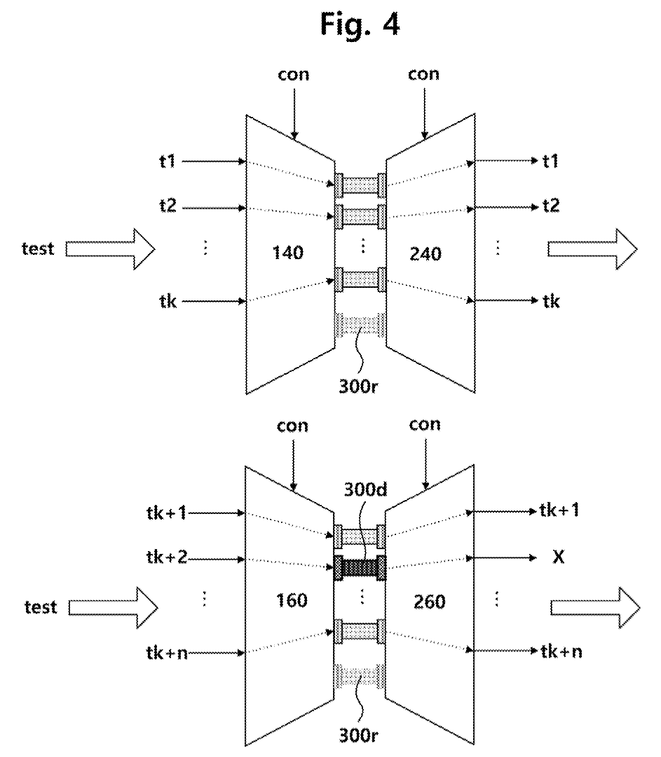

FIG. 4 is a diagram for schematically explaining the operation of the first TX lane recovery unit 140 and first RX lane recovery unit 160 and the second RX lane recovery unit 240 and second TX lane recovery unit 160. Referring to FIGS. 3 to 4, the first die D1 and second die D2 receive test patterns and control signals provided by the compiler, and the first bridge 110 provides control signals to the first control unit 120. Also, the second bridge 210 provides control signals and test patterns to the second control unit 220.

In the defect management mode, the first TX lane recovery unit 140 and first RX lane recovery unit 160 are controlled by the control signal con provided by the first control unit 120 and can each be implemented as multiple multiplexers. In the defect management mode, the second RX lane recovery unit 240 and second TX lane recovery unit 260 are controlled by the control signal con provided by the second control unit 220 and can each be implemented as multiple demultiplexers.

For example, the multiplexer can be implemented as an n:k multiplexer (n, k: natural numbers), and for example, the demultiplexer can be implemented as a k:n demultiplexer (n, k: natural numbers). The connecting member 300 can include redundant connecting members. The ratio of redundant lanes to lanes of multiplexers and demultiplexers varies depending on the number of spare pads, and can include redundant connecting members 300r at ratios of 4:1 to 10:1.

The first TX lane recovery unit 140 and first RX lane recovery unit 160 are controlled by the control signal con from the first control unit 120 to function as multiplexers. Also, the second RX lane recovery unit 240 and second TX lane recovery unit 260 are controlled by the control signal con from the second control unit 220 to function as demultiplexers.

The first bridge 110 provides test patterns test to the first transmission unit 130 and first reception unit 150 set to function as transmitters through the first control unit (S200). The test patterns test provided by the first transmission unit 130 and first reception unit 150 are provided to the first TX lane recovery unit 140 and first RX lane recovery unit 160 illustrated in FIG. 4, and provided to the second die D2 through the connecting member 300.

If no failure occurs in the connecting member 300, the bits of the provided test pattern test are input to the second RX lane recovery unit 240 and second TX lane recovery unit 260 through the first TX lane recovery unit 140 and first RX lane recovery unit 160. However, failures such as non-bonding and cracks can occur in pads and/or bumps included in the connecting member 300. For example, if failures such as cracks occur in the connecting member 300, it can form resistance values larger than normal resistance values, form open circuits or short circuits, or form higher capacitance than normal capacitance. Therefore, the connecting member 300 where failure occurred can output signals different from input signals or fail to output signals.

The second reception unit 230 and second transmission unit 250 controlled to perform receiver functions provide the provided signals to the second bridge 210, and the second bridge 210 outputs the input signals to the second control unit 220.

The second control unit 220 compares the signals input to the second die D2 with the predetermined signals provided by the second bridge 210 to identify the failure and failure location of the connecting member 300. As described above, since signals input to the second die D2 through the connecting member 300 where failure occurred differ from the test pattern stored by the second control unit 220, the second control unit 220 can identify the failure and failure location through bit-by-bit comparison of the stored test pattern (S300). In one embodiment, the second control unit 220 can provide and share the identified failure location of the connecting member 300 to the first control unit 120.

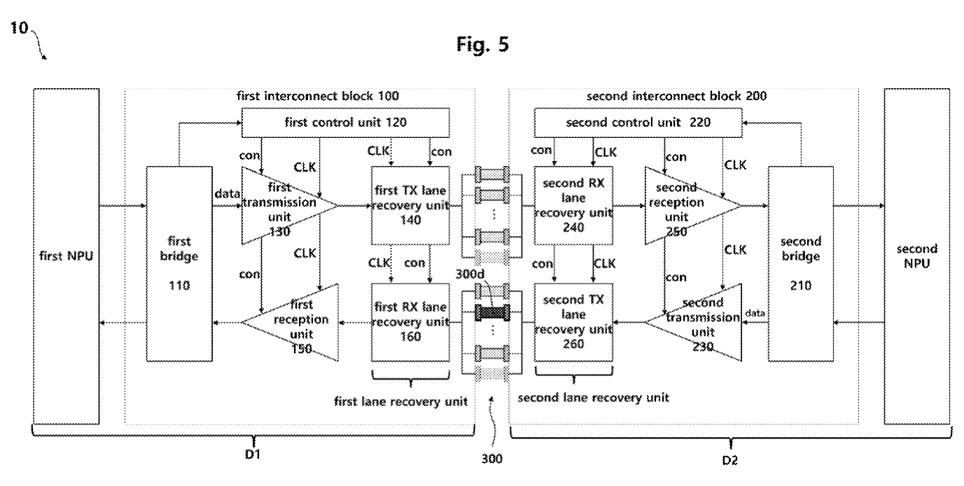

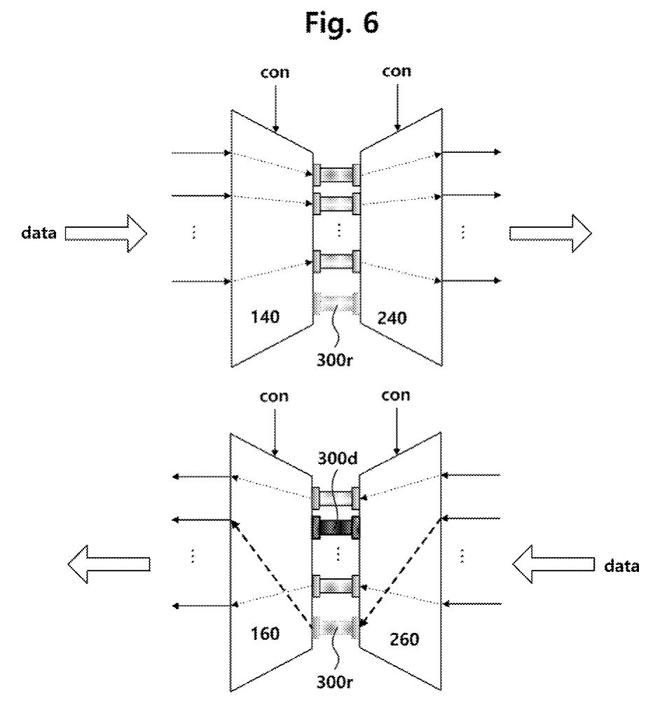

When failure detection is completed, the communication apparatus 10 operates in communication mode (S400). FIG. 5 is a schematic diagram for explaining when the communication apparatus 10 operates in communication mode, and FIG. 6 is a diagram for schematically explaining the operation of the first TX lane recovery unit 140 and first RX lane recovery unit 160 and the second RX lane recovery unit 240 and second TX lane recovery unit 160 in communication mode. Referring to FIGS. 5 to 6, the first transmission unit 130 and first reception unit 150 are controlled by the control signal con provided by the first control unit 120 to function as transmitter and receiver respectively, and the second transmission unit 230 and second reception unit 250 are controlled by the control signal con provided by the second control unit 220 to function as transmitter and receiver respectively.

Also, the first TX lane recovery unit 140 and first RX lane recovery unit 160 are controlled by the control signal con provided by the first control unit 120 to function as multiplexer and demultiplexer respectively. The second TX lane recovery unit 260 and second RX lane recovery unit 240 are controlled by the control signal con provided by the second control unit 220 to function as multiplexer and demultiplexer respectively.

The first control unit 120 and second control unit 220 store information about connecting members where failure occurred. In the illustrated embodiment, since there is no failure in the connecting member electrically connecting the first TX lane recovery unit 140 functioning as a multiplexer and the second RX lane recovery unit 240, the first control unit 120 and second control unit 220 may not provide control signals to bypass to redundant connecting members.

However, since there is failure in the connecting member electrically connecting the second TX lane recovery unit 260 functioning as a multiplexer and the first RX lane recovery unit 160, the first control unit 120 and second control unit 220 provide control signals to the second TX lane recovery unit 260 and first RX lane recovery unit 160 to bypass the connecting member where failure occurred and perform communication through redundant connecting members. Therefore, communication can be performed through redundant connecting member 300r that bypasses the failed connecting member 300d. In one embodiment, after operating in communication mode, the communication apparatus 10 can operate in defect management mode periodically or intermittently to detect communication failures.

The communication apparatus 10 of the present embodiment described above performs only the function of recovering communication failures between dies, unlike existing general-purpose controllers, so it can reduce the die area required to form the communication apparatus 10 and the power required for operation, providing advantages of high economics and efficiency.

At least one of the components, elements, modules or units (collectively "components" in this paragraph) represented by a block or an equivalent indication in the drawings including FIGS. 1 and 3-6 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

While the present invention has been described with reference to embodiments shown in the drawings to aid understanding of the present invention, these are embodiments for implementation and are merely exemplary. Those skilled in the art will understand that various modifications and equivalent other embodiments are possible therefrom. Therefore, the true technical protection scope of the present invention should be determined by the appended claims.

What is claimed is:

1. A communication apparatus comprising:
a first interconnect block included in a first die and a second interconnect block included in a second die, each operating in a communication mode or a defect management mode that manages communication failures, and
a connecting member that transfers data between the first interconnect block and the second interconnect block,
wherein the first interconnect block transmits a test pattern through the connecting member in the defect management mode, and the second interconnect block detects the communication failure by determining whether the test pattern received through the connecting member matches a predetermined test pattern.

2. The communication apparatus of claim 1, wherein the first interconnect block includes a first control unit and a first lane recovery unit, the second interconnect block includes a second control unit and a second lane recovery unit, and the second control unit and the first control unit share data of the connecting member where the failure occurred and control the first lane recovery unit and the second lane recovery unit to bypass the connecting member where the failure occurred.

3. The communication apparatus of claim 2, wherein the connecting member includes a plurality of redundant connecting members, and
in the communication mode, the first control unit and the second control unit control the first lane recovery unit and the second lane recovery unit to bypass the connecting member where the failure occurred and communicate through the redundant connecting member.

4. The communication apparatus of claim 2, wherein the first lane recovery unit includes a first TX lane recovery unit and a first RX lane recovery unit,
the second lane recovery unit includes a second RX lane recovery unit and a second TX lane recovery unit, the first TX lane recovery unit is coupled with the second RX lane recovery unit, and the second TX lane recovery unit is coupled with the first RX lane recovery unit.

5. The communication apparatus of claim 4, wherein in the defect management mode, the first TX and RX lane recovery units function as multiplexers, and the second TX and RX lane recovery units function as demultiplexers.

6. The communication apparatus of claim 1, wherein the connecting member includes at least one of a bump and a pad.

7. The communication apparatus of claim 1, wherein the first die includes a first NPU (Neural Processing Unit) connected to the first interconnect block, and the second die includes a second NPU connected to the second interconnect block.

8. The communication apparatus of claim 1, wherein the communication apparatus is driven in the defect management mode during boot-up and periodically or intermittently during communication mode operation.

9. A method for driving a first interconnect block included in a first die and a second interconnect block included in a second die operating in communication mode and defect management mode, the method comprising:
in the defect management mode:
setting the first interconnect block included in the first die and the second interconnect block included in the second die to defect management mode respectively,
transmitting a predetermined test pattern from the first interconnect block to the second interconnect block through a connecting member, and
detecting a connecting member where failure occurred by comparing the signals input to the second die with the predetermined test pattern, and
the communication mode comprising:
setting the first interconnect block and the second interconnect block to communication mode for mutual communication, and
communicating while the first interconnect block and the second interconnect block bypass the detected failed connecting member.

10. The method of claim 9, wherein the first interconnect block includes a first control unit and a first lane recovery unit, the second interconnect block includes a second control unit and a second lane recovery unit, and in the defect management mode, the second control unit and the first control unit share data of the connecting member where the failure occurred.

11. The method of claim 10, wherein in the communication mode, the first control unit and the second control unit control the first lane recovery unit and the second lane recovery unit to bypass the connecting member where the failure occurred and communicate through redundant connecting members.

12. The method of claim 10, wherein the first lane recovery unit includes a first TX lane recovery unit and a first RX lane recovery unit, the second lane recovery unit includes a second RX lane recovery unit and a second TX lane recovery unit, the first TX lane recovery unit is coupled with the second RX lane recovery unit, and the second TX lane recovery unit is coupled with the first RX lane recovery unit.

13. The method of claim 12, wherein in the defect management mode, the first control unit controls the first TX and RX lane recovery units to function as multiplexers, and the second control unit controls the second TX and RX lane recovery units to function as demultiplexers.

14. The method of claim 9, wherein the connecting member includes at least one of a bump and a pad.

15. The method of claim 9, wherein the first die includes a first NPU (Neural Processing Unit) connected to the first interconnect block, and the second die includes a second NPU connected to the second interconnect block.

16. The method of claim 9, wherein the defect management mode is performed during boot-up of the first die and second die and periodically or intermittently while the first die and second die operate in the communication mode.
